(19) United States
(12) Patent Application Publication
(10) Pub. No.: US 2015/0014221 A1
(43) Pub. Date: Jan. 15, 2015

(54) COMPOSITION, METHOD, AND APPARATUS FOR CRUDE OIL REMEDIATION

(71) Applicant: New York University, New York, NY (US)

(72) Inventor: Sungho Yoon, Edgewater, NJ (US)

(21) Appl. No.: 14/325,616

(22) Filed: Jul. 8, 2014

Related U.S. Application Data
(60) Provisional application No. 61/844,061, filed on Jul. 9, 2013.

(51) Int. Cl. B01J 19/10; C10G 1/04

(52) U.S. Cl. CPC B01J 19/10; C10G 1/045; B01J 2219/089
USPC 208/390; 422/128; 252/60

(57) ABSTRACT

Crude oil-contaminated objects are remediated by mixing crude oil-contaminated objects with an aqueous solution including co-solvents, electrolytes, and anionic surfactants. The co-solvents are selected from the group consisting of secondary butyl alcohol and isopropanol. The electrolytes are selected from the group consisting of calcium chloride and sodium chloride. The aqueous solution comprises between 5% and 10% of secondary butyl alcohol by weight; between 1% to 8% of an anionic surfactant by weight; and between 3000 mg/L and 5000 mg/L electrolytes.

### RELATED APPLICATION

This application claims benefit to Provisional Application Ser. No. 61/844,061, “COMPOSITION, METHOD, AND APPARATUS FOR CRUDE OIL REMEDIATION;” filed on Jul. 9, 2013, the entirety of which is incorporated herein by reference.

### BACKGROUND

1. Field of the Invention

This invention relates generally to a composition used in remediating crude oil related contamination and a method and apparatus for cleaning up objects contaminated by crude oil.

2. Background Discussion

Crude oil, a critical energy source, imposes considerable environmental and health risks in several ways. First of all, crude oil is hydrophobic, which means that it cannot be effectively dissolved and collected with water. It also has a large number of chemical constituents, including phenolics, polycyclic aromatic hydrocarbons (PAHs) (e.g., naphthalene), and monocyclic aromatics (e.g., benzene) [5], many of them are toxic organic compounds, such as benzene, toluene, phenol, naphthalene, anthracene, and others, which are probable human carcinogens [2, 3, 4]. An oil spill may occur at any place or any time due to human errors or natural disaster. Oil spills have been reported to occur in transportation tankers, offshore platforms, drilling rigs and wells, and refineries that process petroleum products (such as gasoline, diesel). Finally, when crude oil is released to its surrounding environment, it may stay in the contaminated objects for many years and keep destroying the ecosystem surrounding the contaminated objects continuously.

The major task after an oil spill is how to effectively recollect the spilled crude oil from the contamination sites to avoid long term damage to the environment. Generally speaking, there has been a long felt need for an effective technology that remediates crude oil contaminated sites in a relatively short period of time at an acceptable cost. An effective remediation technology needs to satisfy multiple requirements, such as low cost, short recovery time, and high recovery rate. So far, most available methods to clean up crude oil are ineffective due to the challenges created by the unique composition of crude oil, the nature of the contaminated medium, and the weathering process of crude oil.

The composition of crude oil varies from site-to-site due to differences in the initial composition and due to the degree of weathering. A formula that effectively treats crude oil from one site may not have similar effectiveness when used to treat crude oil from another site. Whether to alter the formula or treatment method according to a particular composition of the crude oil would depend on many considerations, including effectiveness, cost, and practicability.

The medium that holds the spilled crude oil also creates additional difficulties for a clean-up operation. Typical mediums include ocean, beach sand, soil, and underground stones or rocks. NAPLs are particularly difficult to recover from saturated porous media, such as sand on beaches or soils at contamination sites, and are often found at residual saturations that act as a long-term groundwater contamination source [16, 17, 18]. While NAPL at saturations above residual saturation is mobile and can be recovered, the complete recovery of NAPL from the subsurface is impossible by conventional means due to its hydrophobicity [19, 20]. Trapped within soil pores by capillary forces and highly viscous, the NAPL saturation cannot be reduced below residual saturation using water pressure alone [21, 22, 23]. Furthermore, since the aqueous solubility of crude oil is very low, recovery of the crude oil by dissolution and conventional pump and treat (“P&T”) technology will take time periods on the order of decades [24]. Lee [25] found that even after 130 years of dissolution, a pool of coal tar still remains as a source of groundwater pollution. The mass recovery of crude oil using P&T may also be prolonged due to the formation of the viscous or solid-like film at the crude oil/water interface discussed above. Dissolution of the crude oil components can become rate-limited by diffusion through this film [5].

The effects of weathering and exposure to water have a unique impact on coal tar, since several of the common PAH constituents of crude oil are solids, an insoluble form, at room temperature. Researchers have examined the stability of certain synthetic, multi-component, non-aqueous phase liquids (“NAPL”), specifically those containing multiple PAHs [9-11] representing the composition of crude oil. They found that the mass transfer behavior of the different components was dependent upon their mole fraction within the NAPL, which can explain why it is difficult to dissolve weathered coal tar. As coal tar weathers, or when the weathering is expedited by remediation efforts such as pump and treat, the lighter components of the tar partition into the water at a higher rate than the heavier components, effectively increasing the mole fraction of the heavier components until they reach their solubility limits. As a result, these portions precipitate out of the NAPL and transform into a semi-solid or solid form. Other work that examines the mass transfer and bioavailability of PAHs from crude oil can be found in Ramaswami et al. [12, 13].

Researchers also used computer simulations to examine the preferential dissolution of crude oil constituents [14]. It was noticed that the lower molecular weight compounds were removed from the system first. Accordingly, this causes the concentration of higher molecular weight compounds to increase within the crude oil, and therefore increase in concentration in the aqueous phase. The models predicted a 75% decrease in aqueous concentration of anthracene (a 3-ring PAH) over a 30 year period, but an increase of over 50% in benzo[a]pyrene (a 5-ring PAH) concentrations at the end of the same period. This model did not take into consideration the reduction in diffusion due to the likely changes in tar at the interface resulting from the precipitation of the heavier components and subsequent formation of a solid-like film.

Theses behaviors have important implications for crude oil remediation, such as the rapid decrease of capability for in-situ treatment like conventional pump & treat. Bioremediation or natural attenuation can make the remediation effort ineffective within a short time period. It is interesting to point out that in spite of these laboratory observations, field-obtained samples of weathered tar still showed naphthalene (a volatile, low molecular weight compound) to be the most dominant compound [15]. Birak and Miller [15] point out that this phenomenon, as well as other aspects of crude oil and other tars from former manufactured gas plants (“FMGP”) need better understanding in order to “improve our decision making ability with regard to remedial options.” The present invention focuses on using solutions that will greatly enhance the solubility of all the coal tar components, minimizing the disproportionate dissolution behavior effect and significantly decreasing remediation times over P&T.

### SUMMARY

An aspect of the present disclosure is directed to an apparatus for remediating crude oil-contaminated objects. The apparatus comprises a container; and a mixer that mixes crude oil-contaminated objects with an aqueous solution including co-solvents, electrolytes, and anionic surfactants. The co-solvents may be, for example, secondary butyl alcohol or isopropanol. The electrolytes may be, for example, calcium chloride or sodium chloride.

According to an embodiment of the present disclosure, the apparatus further comprises an ultrasound creator that creates and applies ultrasound to the mixture of the aqueous solution and the crude oil-contaminated objects.

According to yet another embodiment of the present disclosure, the apparatus further comprises an air bubble creator that introduces air bubbles into the mixture of the aqueous solution and the crude oil-contaminated objects.

According to yet another embodiment of the present disclosure, the apparatus further comprises a heater that raises the temperature of the mixture of the aqueous solution and the crude oil-contaminated objects.

According to yet another embodiment of the present disclosure, the apparatus further comprises a collector that collects separated crude oils from the mixture of the aqueous solution and the crude oil-contaminated objects.

According to yet another embodiment of the present disclosure, the crude oil-contaminated objects include oil-contaminated sand, aquifer, or soil.

According to yet another embodiment of the present disclosure, the aqueous solution includes about 5% surfactant by weight, about 5% co-solvent by weight, and about 4000 mg/L calcium chloride.

Another aspect of the present disclosure is directed to a method for remediating crude oil-contaminated objects. The method comprises determining contaminants in crude oils that contaminate the objects; selecting a surfactant based on the contaminants; mixing crude oil-contaminated objects with an aqueous solution including co-solvents, electrolytes, and anionic surfactants.

According to yet another embodiment of the present disclosure, the method further comprises applying ultrasound to the mixture of the aqueous solution and the crude oil-contaminated objects.

According to yet another embodiment of the present disclosure, the method further comprises introducing air bubbles into the mixture of the aqueous solution and the crude oil-contaminated objects.

According to yet another embodiment of the present disclosure, the method further comprises raising the temperature of the mixture of the aqueous solution and the curde oil-contaminated objects.

According to yet another embodiment of the present disclosure, the method further comprises collecting separated crude oils from the aqueous solution and the oil-contaminated objects.

Yet, another aspect of the present disclosure is directed to an aqueous solution for remediating crude oil-contaminated objects. The aqueous solution comprises between 5% to 10% of secondary butyl alcohol by weight of the aqueous solution; between 1% to 8% of an anionic surfactant by weight of the aqueous solution; and between 3000 mg/L to 5000 mg/L of electrolytes.

According to an embodiment of the present disclosure, the anionic surfactant includes alcohol propoxysulfate.

According to yet another embodiment of the present disclosure, the alcohol propoxysulfate is between 2% and 6% by weight.

According to yet another embodiment of the present disclosure, the secondary butyl alcohol is about 5% by weight.

According to yet another embodiment of the present disclosure, the electrolytes are about 4000 mg/L of calcium chloride.

According to yet another embodiment of the present disclosure, the aqueous solution further comprises at least 1% of propylene glycol by weight.

### BRIEF DESCRIPTION OF DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 shows a remediation method for crude oil-contaminated objects according to an embodiment of the present disclosure.

FIG. 2 shows a Type III-like phase behavior according to an embodiment of the present disclosure.

FIG. 3 shows a Type II-like phase behavior according to an embodiment of the present disclosure.

FIG. 4 shows a Type I-like phase behavior according to an embodiment of the present disclosure.

FIG. 5 shows the effect of electrolyte concentrations on the remediation capacity of the solutions according to an embodiment of the present disclosure.

FIG. 6a shows crude oil-contaminated sand before processing according to an embodiment of the present disclosure.

FIG. 6b shows clean sand after the remediation process according to an embodiment of the present disclosure.

FIG. 7 shows methylene chloride solutions dissolving all residual oils in treated sand according to an embodiment of the present disclosure.

FIG. 8 shows an environmental impact analysis according to an embodiment of the present disclosure.

FIG. 9 shows another environmental impact analysis according to an embodiment of the present disclosure.

FIG. 10 shows an apparatus for remediating crude oil-contaminated objects according to an embodiment of the present disclosure.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. Embodiments of the present invention are disclosed or are apparent from and encompassed by, the following description.

Effect of Surfactants

Surfactants represent molecules that have both hydrophilic (water-liking) and lipophilic (water-disliking) moieties. Therefore, they exhibit solubility in both water and oil. The amphiphilic nature of surfactant molecules causes them to accumulate at interfaces. When surfactants are added to water or solvents, the surface tension of the systems is reduced for one of the following purposes: wetting, emulsifying, dispersing, foaming, scouring or lubricating.

Surfactants are typically classified by the nature of their head group as nonionic, cationic, and anionic. Nonionic surfactants are characterized by hydrophilic head groups that do not ionize appreciably in water. Examples include polyoxyethylenated alkylphenols, alcohol ethoxylates, alkylphenol ethoxylates, and alkanolamides. Nonionic surfactants tend to be good solubilizers and are relatively nontoxic. They are usually easily blended with other types of surfactants (i.e., used as cosurfactants) and therefore have found widespread use in petroleum and environmental applications. The performance of nonionic surfactants, unlike anionic surfactants, is relatively insensitive to the presence of salts in solution (Guha et al., 1998; Battelle, 2002).

Cationic surfactants yield a positively charged surfactant ion (hence cationic) and a negatively charged counterion upon dissolution in water. Examples include polyamines and their salts, quaternary ammonium salts, and amine oxides. Cationic surfactants tend to be toxic and are therefore not widely used in environmental applications at this time. Cationic surfactants also tend to absorb to anionic surfaces and so can be severely retarded in groundwater systems (Battelle, 2002).

Anionic surfactants have been used for surfactant enhanced aquifer remediation applications (“SEAR”) more frequently because soil surfaces are generally negatively charged, and a negatively charged surfactant will be repelled, rather than attracted to the soil surface. Anionic surfactants give rise to a negatively charged surfactant ion (hence anionic) and a positively charged counterion upon dissolution in water. Examples of anionic surfactant groups include sulfonic acid salts, alcohol sulfates, alkylbenzene sulfonates, phosphoric acid esters, and carboxylic acid salts. Anionic surfactants tend to be good solubilizers and are relatively nontoxic. They have been used in petroleum oil recovery operations as well as in contaminant hydrogeology remediation applications (Battelle, 2002).

When two or more different types of surfactant molecules are dissolved in water, micelles with mixed compositions are formed, that is, an aggregate contains representatives of each type of amphiphile present in the aqueous solution. Furthermore, the proportion of each type of amphiphile in a given micelle may be very different from its overall proportions present in the solution. In ideal mixing, the mixture properties can be predicted assuming that the micellar pseudophase is an ideal mixture of surfactant. However, there are surfactant mixtures that do not obey this ideal mixing. The thermodynamics of mixed micelles requires special consideration.

Choosing the correct surfactant to have a particular effect may be difficult. The complex chemistry of surfactants is evaluated to ensure selection of an optimal surfactant for the contaminant, groundwater, and soil characteristics. The properties considered for a particular application can be formulated into a product that includes the consideration of minimal propensity to form liquid crystals, gels, or macroemulsions; cloud point, rapid, coalescence, HLB function, high contaminant solubilization, ethylene oxide content, contaminant mobilization, low critical micelle concentration, and recycling.

When oil, water, and surfactant are blended together and allowed to equilibrate, two or more phases may appear, and in many cases almost the entire inventory of surfactant will reside in one of the phases together with various proportions of oil and water. The phase containing the bulk of the surfactant is often called the micellar phase, although it may, from time to time, also be termed a microemulsion. The phase behavior of three components systems can, at fixed pressure, salinity, and temperature, be represented using a ternary diagram. Then, phase boundaries of systems containing more than three components can also often be shown in ternary diagrams. The ideal phase behavior is classical microemulsions of Winsor Type I or Type III, depending on the electrolyte concentration (salinity). The literature shows that sulfosuccinate solutions have the classical Winsor Type I-Type III-Type II-phase behavior with increasing salinity for a variety of chlorinated solvents.

Indicators of good compatibility between the selected surfactant solution and the crude oil include rapid equilibration, absence of gel formation or anisotropic behavior, and a high degree of coal-tar solubilization [14, 36, 37, 38, 39]. Gels and other viscous behavior are highly undesirable. This is usually an indication that the surfactant solution is forming an anisotropic structure instead of the desired microemulsion (“m.e.”). The use of a co-solvent often helps to promote m.e. and prevent gel formation. Rapid equilibration is desirable because it demonstrates that an m.e. is forming. For effective on-site crude oil recovery, a high degree of solubilization should be demonstrated during phase behavior testing, but is usually a secondary consideration while preventing gel formation is primary.

Effect of Electrolyte

When a NAPL is mixed with a surfactant solution, the resulting m.e. and degree of solubilization is affected by electrolyte concentration, as well as temperature [40]. For example, in a surfactant solution having 4% active by weight surfactant, 4% secondary butyl alcohol and crude oil at salinities of 0, 100, 1,000, 5,000, and 10,000 mg/L CaCl₂ at 20° C., the solubilization of crude oil components ranges from 39,000 mg/L to 155,000 mg/L. When the CaCl₂ is replaced with NaCl, the solubilization of crude oil components ranges from 1,300 mg/L to 5,500 mg/L. Based on the observation of experimental results with 4% active by weight surfactant, 4% secondary butyl alcohol and crude oil, the solubilization of crude oil using CaCl₂ is between 28 to 49 times better than NaCl as electrolyte.

In the field, various methods can be used (known as “preconditioning”) to control the salinity and temperature of the zone being treated so that the remedial fluid is injected into a favorable environment. Additionally, it is noted that technologies exist to isolate a contaminated subsurface (e.g., barrier walls, hydraulic barriers, etc.) so that desired conditions can be maintained. An important consideration is whether mobilization is desired, which would be achieved using a Type III m.e. When the target is a dense non-aqueous phase liquid (“DNAPL”), concern is raised regarding downward movement if the DNAPL is mobilized. The onset of mobilization occurs when the dimensionless Trapping Number (“N_{T}”), which compares the forces that mobilize NAPL to those that trap NAPL, is above 10^{-5 [}41]. Generally, higher degrees of solubilization ratio results in lower interfacial tension (“IFT”), and consequently higher N_{T}, so that a trade-off exists between the desire for a higher degree of solubilization ratio and the desire to keep the N_{T} below 10⁻⁵ and prevent the onset of mobilization. It should be noted that anionic surfactants, however, can be controlled by adjusting salinity so that the degree of NAPL solubilization is controllable. Lower solubilization results in a Type I m.e., thus, a Type I m.e. is ideal to recover DNAPL without mobilization using anionic surfactant solutions.

Effect of Co-Solvent

Alcohol has been used as a co-solvent in many surfactants solutions. The main purpose of the addition of a co-solvent is to lower the equilibration times of the microemulsions and to eliminate gel/liquid crystals. This is attributed to alcohol partitioning between the oil, water and surfactant micelles. Heavier alcohols partition strongly to the oil within micelles and shift the phase behavior from Winsor Type Ito III or even II. In the present disclosure, isopropanol and secondary butyl alcohol are used as co-solvents. It has been believed that secondary butyl alcohol causes lower optimal salinity. A surfactant solution containing 4% active alcohol propoxylate sulfate sodium salt by weight, 4% secondary butyl alcohol by weight and 5,000 mg/L NaCl, can dissolve azulene as high as 3,548 mg/L, but the concentration of azulene decreases to 1,006 mg/L when the secondary butyl alcohol is replaced by IPA.

Effect of Temperature

The remediation behavior of a surfactant solution is also affected by temperature. A higher probability of gel and liquid crystal formation and longer equilibration time can be expected at a lower temperature. Generally speaking, the solubilization of crude oil components also increases with temperature. For example, for a surfactant solution containing 4% active alcohol propoxylate sulfate sodium salt, 4% secondary butyl alcohol and CaCl₂, the average concentration of coal tar dissolved in the solution at 20° C. and 60° C. are 115% and 140% (respectively) greater than at 17° C. With solution of 4% active sodium dihexyl sulfosuccinate, 4% secondary butyl alcohol and CaCl₂, the average concentration of coal tar at 20° C. and 60° C. are 124% and 156% (respectively) greater than at 17° C. With the surfactant formulation of 3% active alcohol propoxylate sulfate sodium salt, 1% active sodium dihexyl sulfosuccinate, 4% secondary butyl alcohol and CaCl₂, the average concentration of coal tar at 20° C. and 60° C. are 107% and 155% greater than at 17° C.

Effect of Other Additives

Special additives may be added to the surfactants based on various proposes. For example, propylene glycol may be added so that the solution can work properly under high pressure and high temperature conditions. Sodium xylene sulfonate may also be added to further reduce the surface tensions between the surfactants and the solvent.

### Overview of the Composition for Crude Oil Remediation According to an Embodiment of the Present Disclosure

According to an embodiment, the composition used for remediating crude oil contaminated objects includes a main solvent, co-solvents, a surfactant mixture, and electrolytes. The main solvent includes water or any other similar polar solvent. The co-solvents include Isopropyl Alcohol (IPA), Secondary Butyl Alcohol (SBA), or other similar organic solvents. The surfactant mixture may include one or more surfactants and other additives. The surfactants used in the composition may be one or more selected from the group of alcohol propoxysulfate, C12-C19 branched/linear, proxylated sulfated alcohols, sodium diamyl sulfosuccinate (C₁₄H₂₅O₇NaS), propylene glycol, sodium dioctyl sulfosuccinate (C₂₀H₃₇O₇NaS), sodium dihexyl sulfosuccinate (C₁₆H₂₉O₇NaS), octyl phenol ethoxylate, sodium xylene sulfonate, polyoxyethylene 20 sorbitol, sodium dihexyl sulfosuccinate polyoxyethylene, and sodium xylene sulfonate. The additives are used to increase the workability of the composition at high temperature or high pressure, which may include a pressurizer, such as propylene glycol. The electrolytes used in the composition may include sodium salt such as sodium chloride or calcium chloride. The concentration of the co-solvent is at least 5% by weight, preferably from 5% to 10%. The electrolyte concentration is between 3000 mg/L and 5000 mg/L, preferably about 4000 mg/L. The surfactant mixture is at least 1% by weight, preferably between 1% and 8%, and more preferably between 2% and 6%. The additives in the surfactant mixture are no more than 5% by weight, preferably less than 1%. Each of the percentages described above represents a weight percentage relative to the overall mass of the composition.

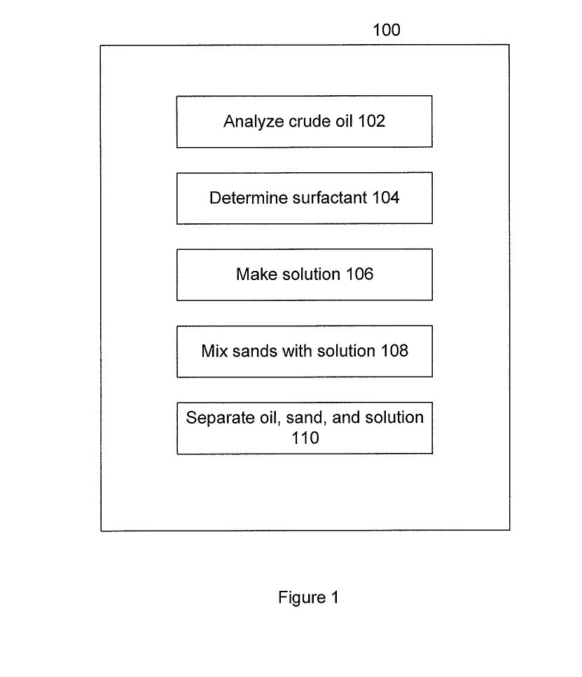

FIG. 1 shows the crude oil clean up process according to an embodiment of the present disclosure. The crude oil clean up method 100 may start with the step 102 of determining the composition of crude oil and then the step 104 of developing suitable surfactants. After the surfactant is determined, the step 106 produces an aqueous solution that contains the surfactants. Then, the method 100 implements a mixing step 108 that includes both a general mixing process and an enhanced mixing process. After the contaminated objects are cleaned, a separation step 110 may be applied to separate the objects, the crude oil, and the remediation solution.

More particularly, the composition determining step 102 determines the chemical constituents of crude oil from a specific contaminated object by using, for example, mass spectroscopy. Several techniques are well-known to a person of ordinary skill in the art to determine the composition of crude oils, such as gas chromatography, mass spectrometer, and combination thereof. The composition of the crude oil is used in the step 104 of developing a suitable surfactant to remediate the contaminated object. The suitable surfactant may be a single molecule specifically designed or tailored to the composition, a commercially available surfactant or a surfactant mixture, a blending surfactant, or a mixture of a surfactant with other additives. The surfactant may be selected based on a plurality of factors, including phase behavior, crude oil recovery rate, remediating time, cost, environmental impact, and combination thereof.

After the surfactant is selected, the step 106 adds the surfactant to a solvent, such as water, together with co-solvents and electrolytes to form a solution. Then, the contaminated object, such as sand, is mixed with the solution for clean up during the general mixing step 108. An enhanced mixing may further heat up the solution to increase the solubility of crude oil in the solution. The enhanced mixing may also use other techniques to increase the mixing between the sand and the solution. For example, the enhanced mixing may use a mixer to stir the sand. The enhanced mixing may also apply ultrasound to the solution.

After the mixing step 108, the crude oil is dissolved in the solution. In the step 110, the sand may be separated from the solution by passing the solution and sand through a filter during the separating step. The separating step 110 may also separate the contaminants from the solution in order to recycle the solution or reduce the environmental impact of the solution. For example, the separating step may lower the temperature of the solution so that the contaminants precipitate from the solution. The separating step 110 may also introduce air bubbles with controlled size to lift the contaminants to the surface of the solution. The lifted contaminants may be subsequently removed from the solution manually, such as by a person, or a mechanical method.

According to an embodiment of the present disclosure, not all of the above-identified steps are required. When a generally effective surfactant is used, the crude oil contaminated object may be cleaned up by only implementing the general mixing step that mixes the crude oil contaminated object with a solution containing the surfactant.

Developing a Suitable Surfactant.

Phase behavior studies were performed to observe and evaluate the behavior of surfactant solution when mixed with crude oil. The experiments were conducted to select surfactants with high contaminant solubilizations, low coalescence/equilibration times, and minimal liquid crystal and gel. An objective is to identify surfactant formulations that are free of problems such as the problems of liquid crystals and gel. The desired behavior is classical microemulsions of Winsor Type I, also known as Type II(−), depending on the electrolyte concentration. The contaminant in this step is crude oil. Various surfactants were tested together with Isopropanol (IPA) and secondary butyl alcohol (SBA) and calcium chloride (CaCl₂).

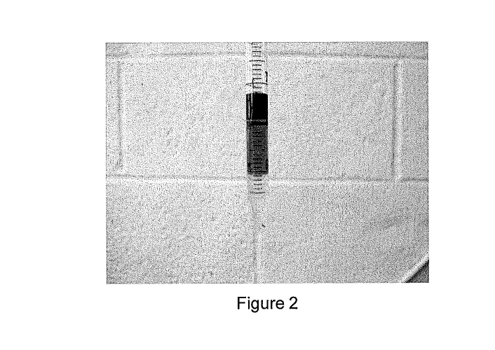

FIG. 2 illustrates an oil-surfactant mixture having a Type III-like phase behavior.

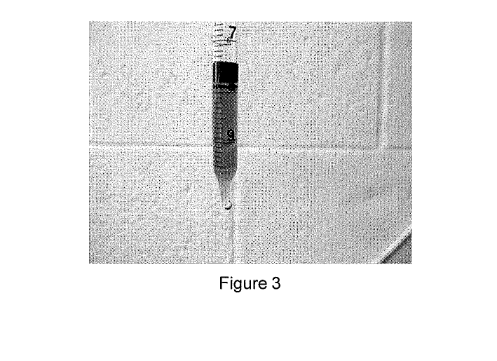

FIG. 3 illustrates an oil-surfactant mixture having a Type II-like phase behavior.

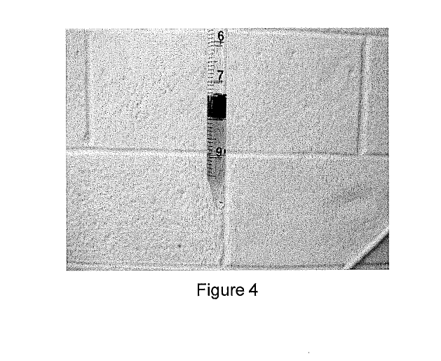

FIG. 4 illustrates an oil-surfactant mixture having a Type I-like phase behavior.

### EXAMPLES

### Example 1

Sand is obtained from Stable Standard Sand (SX0070-3, CAS 14808-60-7). Crude oil is obtained from ConocoPhillips (SDS Number: 724160). The contaminated sand is made by mixing 10 g crude oil with 100 g sand.

The remediation composition includes alcohol propoxysulfate, propylene glycol, sodium xylene sulfosuccinate, and sodium salt.

A 5% aqueous secondary butyl alcohol solution (“SBA solution”) is prepared. A SBA solution is mixed with calcium chloride to have Ca²⁺ concentration at 4000 mg/L (“the Ca²⁺ solution”). Then, a first solution was made of 25 g of Alcohol propoxysulfate and 75 g of the Ca²⁺ solution. A second solution was made of 5.26 g of propylene glycol and 94.74 g of the Ca²⁺ solution. A third solution was made of 10 g of sodium xylene sulfonate and 90 g of the Ca²⁺ solution. The composition solution was made of 40 mL of the first solution, 30 mL of the second solution, 25 mL of the third solution, and 5 ml of the Ca²⁺ solution. The composition solution was mixed in a beaker for 30 minutes.

The remediation starts with mixing 100 mL surfactant solution and 25 g of sand using a magnetic stirrer for 10 minutes and mix again using an Ultrasonic vibrator for 1 minute. Then, the top of the oil was removed using a scraper. Air bubbles were introduced to separate and take out smaller oil chucks or foams (4 min, control bubble size less than 1 cm). Finally, the sand and surfactant solution were separated. The cleaned sand was collected to be tested for residual oil concentration.

This composition and process recover about 98% of the crude oil from the sand in 15 minutes.

### Other Examples

The following compositions, identified as YOA1, YOA2, etc., have been used with aqueous secondary butyl alcohol solution for recollecting crude oils from contaminated sand. The percentage associated with each composition represents the crude oil recovery rate.

YOA1 (75%)—Alcohol propoxysulfate, calcium salt.

YOA2 (78%)—Alcohol propoxysulfate, calcium salt. In this YOA2 example, the composition solution is made by adding 4 g of alcohol propoxysulfate to 96 g of the Ca²⁺ solution as described in Example 1. Then, 100 mL of the composition solution is mixed with 25 g contaminated sand. Following the remediating process similar to that described in Example 1, the composition solution recovers about 78% of the crude oil from the contaminated sand.

YOA3 (72% with calcium salt and 43% with sodium salt)—Alcohols, C12-13-branched and linear, propoxylated, sulfated.

YOA4 (68%)—Alcohols, C14-15-branched and linear, propoxylated, sulfated, calcium salts

YOA5 (55%)—Alcohols, C16-17-branched and linear, propoxylated, sulfated, calcium salts.

YOA6 (62% with calcium salt and 38% with sodium salt)—Alcohols, C18-19-branched and linear, propoxylated, sulfated.

YOA7 (58%)—Sodium diamyl sulfosuccinate(C₁₄H₂₅O₇NaS), calcium salts.

YOW (81%)—Propylene glycol, calcium salts. In this YOW example, the composition solution was made by adding 4 g of propylene glycol to 96 g of the Ca²⁺ solution as described in Example 1. Then, 100 mL of the composition solution was mixed with 25 g contaminated sand. Following the similar remediating process as described in Example 1, the composition solution recovers about 81% of the crude oil from the contaminated sand.

YOO (63%)—Sodium dioctyl sulfosuccinate(C₂₀H₃₇O₇NaS), calcium salts.

YOM (67%)—Sodium dihexyl sulfosuccinate(C₁₆H₂₉O₇NaS), calcium salts.

YOS (79% with calcium salts and 54% with sodium salts)—Sodium xylene sulfonate,

YOB1 (81% with calcium salt and 12% with sodium salt)—Alcohol propoxysulfate, Propylene glycol, Sodium dihexyl sulfosuccinate.

YOB3 (86% with calcium salt and 31% with sodium salt)—Alcohols, C12-13-branched and linear, propoxylated, sulfated, diamyl sulfosuccinate. In this YOB3 example, a first solution was made of 12 g of alcohol C12-13 branched and linear propoxylated sulfated with 88 g of the Ca²⁺ solution as described in Example 1. A second solution was made of 12 g of diamyl sulfosuccinate with 88 g of the Ca²⁺ solution as described in Example 1. Then, the composition solution was made by 50 mL of the first solution and 50 mL the second solution. Then, 100 mL of the composition solution was mixed with 25 g contaminated sand. Following the similar remediating process as described in Example 1, the composition solution recovers about 86% of the crude oil from the contaminated sand.

YOB4 (81% with calcium salt and 29% with sodium salt)—Alcohols, C14-15-branched and linear, propoxylated, sulfated, Propylene glycol.

YOB5 (83% with calcium salt and 32% with sodium salt)—Alcohols, C16-17-branched and linear, propoxylated, sulfated.

YOB6 (71% with calcium salt and 41% with sodium salt)—Sodium dihexyl sulfosuccinate Polyoxyethylene.

YOB7 (73% with calcium salt and 37% with sodium salt)—Sodium dioctyl sulfosuccinate, Alcohol propoxysulfate, Propylene glycol.

YOB8 (65% with calcium salt and 25% with sodium salt)—Sodium dihexyl sulfosuccinate, Alcohol propoxysulfate, Propylene glycol.

YOB9 (68% with calcium salt and 36% with sodium salt)—Sodium xylene sulfonate, Propylene glycol.

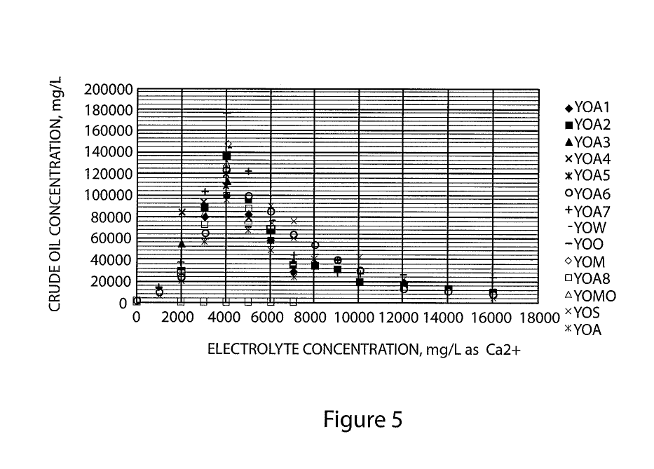

FIG. 5 shows the impact of electrolyte concentration on the remediation results. The horizontal axis represents the concentration of the calcium chloride in the solution while the vertical axis represents the concentration of crude oil in the solution. When the electrolyte concentration is about 4000 mg/L, the crude oil concentration reaches a maximum value compared to other higher or lower electrolyte concentrations.

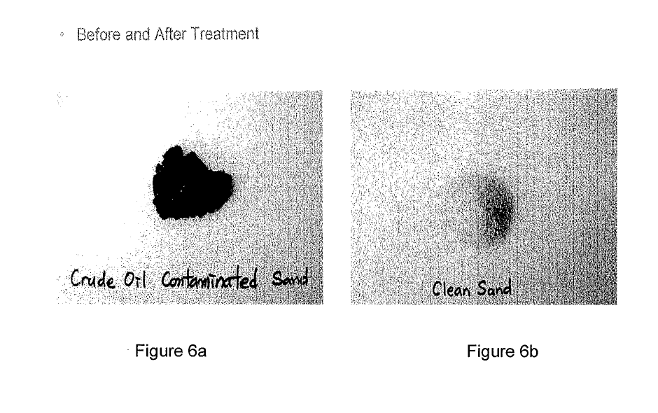

The remediation results of the contaminated sand are also subjected to visual inspections. The first visual inspection is to compare the color of the sand before and after treatment. FIG. 6a shows crude oil contaminated sand before remediation. FIG. 6b shows crude oil contaminated sand after remediation. The contaminated sand as shown in FIG. 6a has a black color, indicating a heavy presence of crude oil in the sand. The cleaned sand as shown in FIG. 6b has a natural white color, indicating an unsubstantial amount of crude oil in the sand.

The second visual inspection is to compare the residual oil that is left in the contaminated sand after the treatment. The contaminated sand, after cleaned by the method according to the present disclosure, is further cleaned by methylene chloride, which will dissolve any residual oil left in the sand. The color of the methylene chloride solution that has passed from the sand, which includes the residual oil, provides another indicator of the effectiveness of the remediation process. In general, a darker color of the methylene chloride solution indicates a higher amount of residual oil.

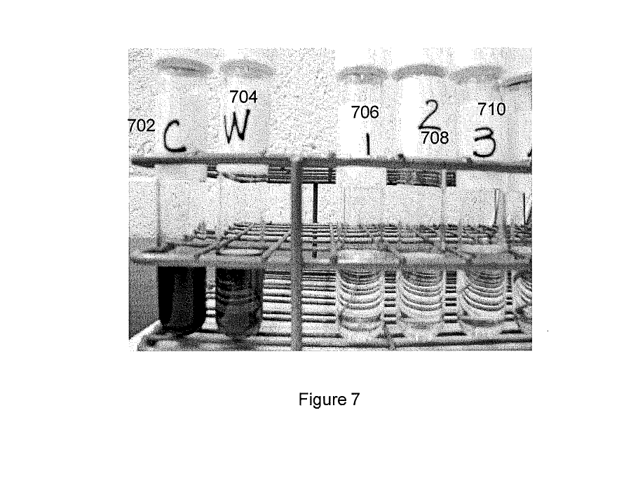

FIG. 7 illustrates the comparison of remediation results by various methods. Sample C 702 represents a methylene chloride solution that dissolves all crude oil of the untreated contaminated sand. Sample C 702 has the darkest color among all illustrated solutions because it has the highest concentration of crude oil. Sample W 704 represents a methylene chloride solution that dissolves all crude oil of water-treated contaminated sand. Sample W 704 also has a dark color because water hardly separates crude oil from contaminated sand. Samples 1-3, 706, 708, and 710, represent methylene chloride solutions that dissolve all crude oils in surfactant-treated contaminated sand according to the present disclosure. Most of these methylene chloride solutions are transparent or close to transparent, which indicates that the residual oil left in the treated sand is minimal.

Although the above description uses crude oil as an example, the invention is applicable to other contaminants, including Jet Fuel and Diesel.

Environmental Impact

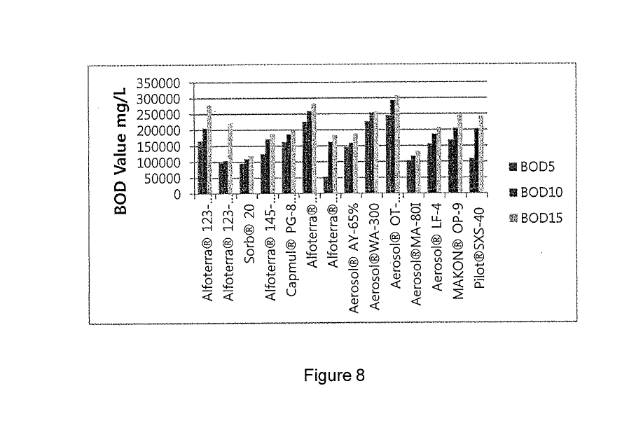

The BOD values are measured and calculated eventually in terms of mg/L. FIG. 8 illustrates all BOD test results, which indicates a normal biodegradation. In coliform bioassay results, the report of coliform density is usually expressed as the number of colonies per 100 mL of sample (CFU/100). Percent population change is the final evidence which compares the result from blank control with the result with surfactant. The following equations are used to calculate the percent population change.

$$C F U / 100 mL = \frac{Coliform colonies counted}{mL of sample filtered} \times 100 \times Dilution R$$

$$Population percent change = \frac{Colonies for Surfactant - Control}{Control} \times 10$$

Since the raw sludge sample from each test could be different, the absolute numbers are therefore not comparable among each test; however, percent change would make all results comparable. The percent change could be positive or negative. If the surfactant prohibits coliform, a negative percent change will be observed. Therefore, a positive change might mean the addition of surfactant has no harmful effect on the bacteria growth. On the other hand, surfactant solution might be utilized by a microorganism as a carbon source.

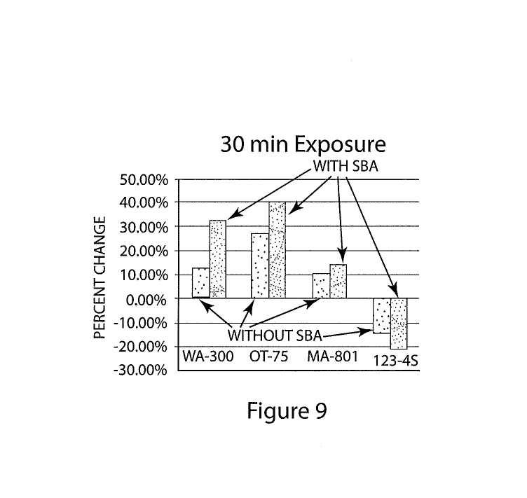

FIG. 9 illustrates the bioassay results. Results of four surfactants, WA-300, OT-75, MA-801, and 123-4S, are shown in FIG. 9. The percentage indicated by each bar represents E. Coli percent change 24 hours after exposure to the surfactants for 30 minutes. For each surfactant, the results were obtained for both with SBA and without SBA. No adverse impact on microbes was found.

In view of both the BOD and Bioassay tests, surfactant Aerosol®123-45, Aerosol® WA-300 and Aerosol® OT-75 showed no toxicity and showed fair bioactivities. Aerosol® MA-801 can be considered to show no toxicity and low biodegradation. MA-801 exhibits a low performance in solubilization with crude oil, and is not recommended for the remediation. As the result of the solubilization test, Aerosol® WA-300 was chosen as the suitable surfactant. The percent change in the bioassay test was also high, which means no harm for microbes. Associated with all performances from every test, wetting agents for pressure sensitive adhesives should be a reasonable choice for surfactant remediation of crude oil.

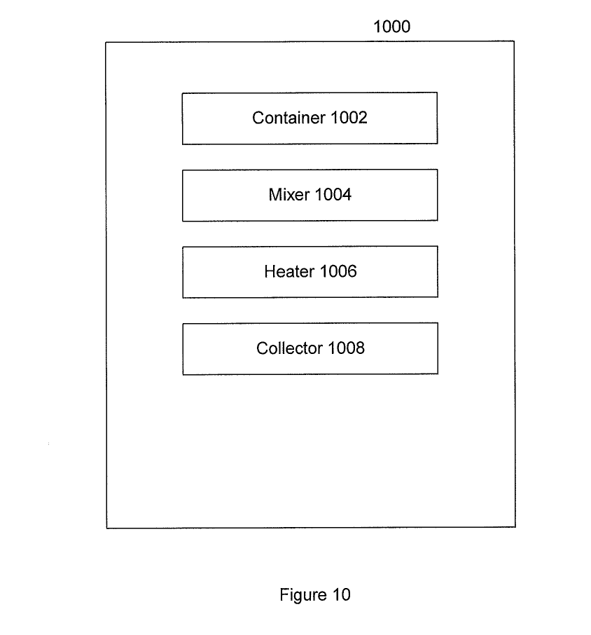

FIG. 10 illustrates an apparatus for remediating crude oil-contaminated sand according to an embodiment of the present invention. The apparatus 1000 includes a container 1002 that holds the solution and the sand, a mixer 1004 that stirs the solution so that all contaminated sand are exposed to the solution adequately, a heater 1006 that raises the temperature of the solution, and a collector 1008 that collects the separated oil from the solution. The mixer 1004 may include a stirrer that mechanically engages the contaminated sand and moves it around. The mixer 1004 may also include an ultrasound transducer that creates and applies ultrasound to the solution. The heater 1006 may use gases or electricity to heat the solution. The collector 1008 includes a mechanical scoop that removes the floating tar from the solution. The collector 1008 may also include a bubble generator that generates bubbles and introduces them into the solution to lift the small oil drops in the solution to the surface. The bubble generator may blow air through a plate with perforations of predetermined sizes and shapes, such as 1 mm holes or 1 cm holes so that the bubble size is controlled. According to another embodiment, the bubble generator includes an air stone. According to an embodiment, the collector 1008 may be a filter that retains the contaminated objects or the emulsion on the surface of the solution. After the contaminated sand is cleaned, the solution in the container is recollected for further processing.

The entirety of the following documents has been herein incorporated by reference.
[1] R. G. Luthy, D. A. Dzombak, C. A. Peters, S. B. Roy, A. Ramaswami, D. V. Nakles, B. R. Nott, Remediating tar-contaminated soils at manufactured gas plant sites, Environ. Sci. Technol., 28 (1994) 266-276.
[2] U.S. EPA, Provisional guidance for quantitative risk assessment of polycyclic aromatic hydrocarbons, US EPA (EPA/600/R-93/069), Ada, Okla., 1993.
[3] M. A. Diez, A. Domonguez, C. Barriocanal, R. Alvarez, C. G. Blanco, C. S. Canga, Hydrogen donor and acceptor abilities of pitches from coal and petroleum evaluated by gas chromatography, J. Chromatogr., A, 830 (1999) 155-164.
[4] D. W. Gaylor, S. J. Culp, L. S. Goldstein, F. A. Beland, Cancer risk estimation for mixtures of coal tars and benzo(a)pyrene, Risk Analysis, 20 (2000) 81-85.
[5] B. Mahjoub, E. Jayr, R. Bayard, R. Gourdon, Phase partition of organic pollutants between water and coal tar under variable experimental conditions, Water Res., 34 (2000) 3551-3560.
[6] C. A. Peters, R. G. Luthy, Coal tar dissolution in water-miscible solvents: experimental evaluation, Environ. Sci. Technol., 27 (1993) 2831-2843.
[7] D. G. Brown, C. D. Knightes, C. A. Peters, Risk assessment for polycyclic aromatic hydrocarbon NAPLs using component fractions, Environ. Sci. Technol., 33 (1999) 4357-4363.
[8] F. Haeseler, D. Blanchet, V. Druelle, P. Werner, J. Vandecasteele, Analytical characterization of contaminated soils from former manufactured gas plants, Environ. Sci. Technol., 33 (1999) 825-830.
[9] E. C. Nelson, S. Ghoshal, J. C. Edwards, G. X. Marsh, R. G. Luthy, Chemical characterization of coal tar-water interfacial films, Environ. Sci. Technol., 30 (1995) 1014-1022.
[10] S. Mukherji, C. A. Peters, W. J. Weber, Mass transfer of polynuclear aromatic hydrocarbons from complex DNAPL mixture, Environ. Sci. Technol., 31 (1997) 416-423.
[11] C. A. Peters, S. Mukherji, C. D. Knightes, W. J. Weber, Phase stability of multicomponent NAPLs containing PAHs, Environ. Sci. Technol., 31 (1997) 2540-2546.
[12] A. Ramaswami, S. Ghoshal, R. G. Luthy, Mass transfer and bioavailiability of PAH Compounds in coal tar NAPL-slurry systems. 1. model development, Environ. Sci. Technol., 31 (1997) 2260-2267.
[13] A. Ramaswami, S. Ghoshal, R. G. Luthy, Mass transfer and bioavailiability of PAH Compounds in coal tar NAPL-slurry systems. 2. experimental evaluations, Environ. Sci. Technol., 31 (1997) 2268-2276.
[14] C. L. Brown, M. Delshad, V. Dwarakanath, D. C. McKinney, G. A. Pope, W. H. Wade, R. E. Jackson, J. L. Londergan, H. W. Meinardous, Demonstration of surfactant flooding of an alluvial aquifer with dense nonaqueous phase liquid, in: M. L. Brusseau, D. A. Sabatini, J. S. Gierke, M. D. Annable (Eds), Innovative Subsurface Remediation: Field Testing of Physical, Chemical, and Characterization Technologies, ACS Symposium Series No 725, Oxford Press, 1999.
[15] P. S. Birak, C. T. Miller, Dense non-aqueous phase liquids at former manufactured gas plants: challenges to modeling and remediation, J. Contam. Hydrol., 105 (2009) 81-98.
[16] J. C. Melrose, C. F. Brandner, Role of capillary forces in determining microscopic displacement efficiency for oil recovery by water flooding, J Can Pet Technol, 13 (1974) 54-62.
[17] G. L. Stegemeier, Mechanisms of entrapment and mobilization of oil in porous media, National meeting of the American Institute of Chemical Engineers, Kansas City, Mo., (1976) paper 13C.
[18] D. M. Mackay, J. A. Chemy, Groundwater contamination: pump and treat remediation, Environ. Sci. Technol., 23 (1989) 630-635.
[19] J. L. Wilson, S. H. Conrad, Is physical displacement of residual hydrocarbons a realistic possibility in aquifer restoration? NWWA/API conference on petroleum hydrocarbons and organic chemicals in ground water-prevention, detection and restoration, Water Well Journal Publishing Company, Worthington Ohio, (1984) 274-298.
[20] J. L. Wilson, S. H. Conrad, W. R. Mason, W. Peplinski, E. Hagan, Laboratory investigations of residual liquid organics from spills, leaks and disposal of hazardous wastes in groundwater, U.S. EPA (EPA/600/6-90/004), Ada, Okla., 1990.
[21] I. Chatzis, N. R. Morrow, Correlation of capillary number relationships for sandtones, SPE J, 24 (1984) 555-562.
[22] K. D. Pennell, G. A. Pope, L. M. Abriola, Influence of viscous and buoyancy forces on the mobilization of residual tetrachloroethylene during surfactant flushing, Environ. Sci. Technol., 30 (1996) 1328-1335.
[23] H. E. Dawson, P. V. Roberts, Influence of viscous, gravitational, and capillary forces on DNAPL saturation, Ground Water, 35 (1997) 261-269.
[24] K. Y. Lee, K. Kostarelos, D. E. Fennell, Modeling the transport of dissolved contaminants originating from a NAPL source containing PAH compounds in groundwater, J. Environ. Sci. Eng., 3 (2004) 541-548.
[25] K. Y. Lee, Modeling long-term transport of contaminants resulting from dissolution of a coal tar pool in saturated porous media, J. Environ. Eng., 130 (2004) 1507-1513.
[26] S. Ghoshal, R. G. Luthy, Biodegradation of naphthalene from coal tar: an assessment of the potential for slurry treatment at MGP sites, Proceedings of the national conference on innovative technologies for site remediation and hazardous waste management, ASCE, Reston, Va., 1995.
[27] S. B. Roy, D. Z. Dzombak, M. A. Ali, Assessment of in situ solvent extraction for remediation of coal tar sites. column studies, Water Environ. Res., 67 (1995) 4-15.
[28] M. A. Lawson, J. G. Venn, L. B. Pugh, T. Vallis, In situ solidification/stabilization pilot study for treatment of coal tar contaminated soils and river sediments, ASTM Special Technical Publication, v1240, 1996.
[29] I. T. Yeom, M. M. Ghosh, C. D. Cox, K. H. Ahn, Dissolution of polycyclic aromatic hydrocarbons from weathered contaminated soil, Water Sci. Technol., 34 (1996) 335-342.
[30] I. F. Paterson, B. Z. Chowdhury, S. A. Leharne, Polycyclic aromatic hydrocarbon extraction from a coal tar-contaminated soil using aqueous solutions of nonionic surfactants, Chemosphere, 38 (1999) 3095-3107.
[31] S. Guha, P. R. Jaffe, C. A. Peters, Solubilization of PAH mixtures by a nonionic surfactant, Environ. Sci. Technol., 32 (1998) 930-935.
[32] L. A. Bernardez, S. Ghoshal, Selective solubilization of polycyclic aromatic hydrocarbons from multicomponent nonaqueous-phase liquids into nonionic surfactant micelles, Environ. Sci. Technol., 38 (2004) 5878-5887.
[33] J. Dong, B. Z. Chowdhry, S. A. Leharne, Altering the spreading coefficient of coal tar systems using ethylene oxide-propolene oxide block copolymers, Colloid Surface A, 266 (2005) 191-199.
[34] A. Link, Effect of nonionic surfactants on dissolution of polycyclic aromatic hydrocarbons from coal tar, J. Hazardous, Toxic, Radioactive Waste, 4 (2000) 78-81.
[35] C. M. Young, V. Dwarakanath, T. Malik, L. Milner, J. Chittet, A. Jazdanian, N. Huston, V. Weerasooriya, In situ remediation of coal tar-impacted soil by polymer-surfactant flooding, Proc. Third international conference on remediation of chlorinated and recalcitrant compounds, Battelle Press, Columbus, Ohio, (2002) 1349-1356.
[36] G. A. Pope, W. H. Wade, Lessons from enhanced oil recovery research for surfactant enhanced aquifer remediation, in: D. A. Sabatini, R. C. Knox, J. H. Harwell (Eds), Surfactant-enhanced subsurface remediation emerging technologies, ACS symposium series 594, American Chemical Society, Washington D. C., (1995) 142-160.
[37] Intera, Surfactant/foam process for aquifer remediation, A report prepared for the Advanced Applied Technology Demonstration Fund (AATDF), 1997.
[38] V. Dwarakanath, K. Kostarelos, G. A. Pope, D. Shotts, W. H. Wade, Anionic surfactant remediation of soil columns contaminated by nonaqueous phase liquids, J. Contam. Hydrol., 38 (1999) 465-488.
[39] U.S. Navy Facilities Engineering Command, Surfactant-enhanced aquifer remediation (SEAR) design manual, NAVFAC Document TR-2206-ENV, Washington, D.C., 2000.
[40] M. Bourrel, R. S. Schechter, Microemulsions and related systems, Surfactant Science Series Vol. 30, Marcel Dekker, New York, 1988.
[41] M. Jin, Surfactant enhanced remediation and interwell partitioning tracer test for characterization of NAPL contaminated aquifers, Ph.D. dissertation, The University of Texas at Austin, Austin Tex., 1995.
[42] C. Huh, Interfacial tensions and solubilizing ability of a microemulsion phase that coexists with oil and brine, J. Colloid Interface Sci., 71 (1979) 408-426.
[43] S. Yoon, Recovery of coal tar using surfactant enhanced aquifer remediation (SEAR), PhD dissertation, Polytechnic University, NY, 2006.
[44] M, Jin, V. Dwarakanath, R. E. Jackson, K. Kostarelos, G. A. Pope, Control of gravity migration of DNAPL in surfactant flooding through viscous forces, Water Resour. Res., 43 (2007) WO1412.
[45] D. Shotts, Surfactant remediation of soils contaminated with chlorinated solvents, MS thesis, The University of Texas at Austin, Austin, Tex., 1996.
[46] K. Kostarelos, Surfactant enhanced aquifer remediation at neutral buoyancy, PhD dissertation, The University of Texas at Austin, Austin, Tex., 1998.
[47] K. Kostarelos, G. A. Pope, B. A. Rouse, G. M. Shook, A new concept: the use of neutrally-buoyant microemulsions for DNAPL remediation, J. Contam. Hydrol., 34 (1998) 383-397.
[48] P. H. Lee, S. K. Ong, J. Golchin, G. L. Nelson, Extraction method for analysis of PAHs in coal tar contaminated soils, J. Hazardous, Toxic, Radioactive Waste, 155 (1999) 155-162.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims

What is claimed is:

1. An apparatus for remediating crude oil-contaminated objects, comprising:
a container; and
a mixer that mixes the crude oil-contaminated objects with an aqueous solution including co-solvents, electrolytes, and anionic surfactants,
wherein the co-solvents are selected from the group consisting of secondary butyl alcohol and isopropanol,
wherein the electrolytes are selected from the group consisting of calcium chloride and sodium chloride.

2. The apparatus according to claim 1 further comprising:
an ultrasound creator that applies ultrasound to the mixture of the aqueous solution and the crude oil-contaminated objects.

3. The apparatus according to claim 1, further comprising:
an air bubble creator that introduces air bubbles into the mixture of the aqueous solution and the crude oil-contaminated objects.

4. The apparatus according to claim 1, further comprising:
a heater that raises the temperature of the mixture of the aqueous solution and the crude oil-contaminated objects.

5. The apparatus according to claim 1, further comprising:
a collector that collects separated crude oil from the mixture of the aqueous solution and the crude oil-contaminated objects.

6. The apparatus according to claim 1, wherein the crude oil-contaminated objects include crude oil-contaminated sand, aquifer, or soil.

7. The apparatus according to claim 1, wherein the aqueous solution includes about 5% surfactant by weight of the aqueous solution, about 5% co-solvent by weight of the aqueous solution, and about 4000 mg/L calcium chloride.

8. A method for remediating crude oil-contaminated objects, comprising:
determining contaminants in the crude oil that contaminate the objects;
selecting a surfactant based on the contaminants; and
mixing the crude oil-contaminated objects with an aqueous solution including co-solvents, electrolytes, and anionic surfactants,
wherein the co-solvents are selected from the group consisting of secondary butyl alcohol and isopropanol, and
wherein the electrolytes are selected from the group consisting of calcium chloride and sodium chloride.

9. The method according to claim 8, further comprising:
applying ultrasound to the mixture of the aqueous solution and the crude oil-contaminated objects.

10. The method according to claim 8, further comprising:
introducing air bubbles into the mixture of the aqueous solution and the crude oil-contaminated objects.

11. The method according to claim 8, further comprising:
raising the temperature of the mixture of the aqueous solution and the crude oil-contaminated objects.

12. The method according to claim 8, further comprising:
collecting separated crude oil from the aqueous solution and the crude oil-contaminated objects.

13. The method according to claim 8, wherein the crude oil-contaminated objects include crude oil-contaminated sand, aquifer, or soil.

14. The method according to claim 8, wherein the aqueous solution includes about 5% surfactant by weight of the aqueous solution, about 5% co-solvent by weight of the aqueous solution, and about 4000 mg/L calcium chloride.

15. The method according to claim 8, wherein the aqueous solution comprises:
between 5% to 10% of secondary butyl alcohol by weight of the aqueous solution;
between 1% to 8% of an anionic surfactant by weight of the aqueous solution; and
between 3000 mg/L to 5000 mg/L of electrolytes.

16. The method according to claim 15, wherein the anionic surfactant includes alcohol propoxysulfate.

17. The method according to claim 16, wherein the alcohol propoxysulfate is between 2% and 6% by weight of the aqueous solution.

18. The method according to claim 17, wherein the secondary butyl alcohol is about 5% by weight of the aqueous solution.

19. The method according to claim 18, wherein the electrolytes are about 4000 mg/L.

20. The method according to claim 19, further comprising at least 1% of propylene glycol by weight of the aqueous solution.

21. An aqueous solution for remediating crude oil-contaminated objects, comprising:
between 5% to 10% of secondary butyl alcohol by weight of the aqueous solution;
between 1% to 8% of an anionic surfactant by weight of the aqueous solution; and
between 3000 mg/L to 5000 mg/L of electrolytes.

22. The aqueous solution of claim 21, wherein the anionic surfactant includes alcohol propoxysulfate.

23. The aqueous solution of claim 22, wherein the alcohol propoxysulfate is between 2% and 6% by weight of the aqueous solution.

24. The aqueous solution of claim 23, wherein the secondary butyl alcohol is about 5% by weight of the aqueous solution.

25. The aqueous solution of claim 24, wherein the electrolytes are about 4000 mg/L.

26. The aqueous solution of claim 25, further comprising at least 1% of propylene glycol by weight of the aqueous solution.

27. The aqueous solution of claim 21, wherein the anionic surfactant includes Alcohol, C12-13-branched and linear, propoxylated, sulfated, diamyl sulfosuccinate.
